(19) United States
(12) Patent Application Publication
(10) Pub. No.: US 2018/0349961 A1
(43) Pub. Date: Dec. 6, 2018

(54) Influence Maximization Determination in a Social Network System

(71) Applicant: Adobe Systems Incorporated, San Jose, CA (US)

(72) Inventors: Sharan Vaswani, Vancouver (CA); Zheng Wen, Fremont, CA (US); Branislav Kveton, San Jose, CA (US); Mohammad Ghavamzadeh, San Jose, CA (US)

(73) Assignee: Adobe Systems Incorporated, San Jose, CA (US)

(21) Appl. No.: 15/611,597

(22) Filed: Jun. 1, 2017

(51) Int. Cl. G06Q 30/02; G06Q 50/00; G06Q 10/06

(52) U.S. Cl. CPC G06Q 30/0269; G06Q 30/0201; G06Q 10/067; G06Q 30/0254; G06Q 50/01

(57) ABSTRACT

Influence maximization determination within a social network system is described. In one example, a subset is selected from a plurality of user accounts of a social network system. Exposure of digital marketing content is then caused to the subset of user accounts. A determination is made as to a probability of each user account of the plurality of user accounts as being influenced by the exposure of the digital marketing content to the subset of user accounts. The determined probability is then output, such as to control output of digital marketing content.

### BACKGROUND

Digital marketing systems are configured to provide digital marketing content to potential consumers to increase awareness and/or conversion of goods or services. To do so, digital marketing systems often employ digital marketing content that includes an offer for a reduced cost in purchasing a good or service, e.g., “10% Off,” “Buy One Get One Free,” and so forth. Although this may incentivize users to make the purchase (i.e., conversion), this has a direct cost to a provider of the good or service. This is because this reduced cost is made available to all users and thus has a corresponding loss in revenue to the provider of the good or service.

According, prior techniques have been developed by digital marketing systems to reduce a cost in providing digital marketing content (and corresponding offers) yet still promote conversion of a good or service. An example of this is referred to as a viral marketing campaign. A viral marketing campaign is employed by the digital marketing system to spread awareness about a specific product or service via “word-of-mouth” information propagation over a social network system, e.g., via electronic communication via the social network system. As a result, a number of offers provided as part of digital marketing content may be reduced by leveraging an effect these offers have on other users that did not receive the offers, themselves.

To do so in one example, the digital marketing system selects a fixed number of user accounts of the social network system (e.g., “seeds”) that are used by “influential” users and provides these user accounts with digital marketing content, e.g., offers for free products or services, discounts, and the like. These “seeds” are then used to exhibit influence on other users and associated user accounts of the social network system to increase awareness of the good or service, result in conversion, and so forth. This results, as a goal of the viral marketing campaign, in propagation of communications between user accounts of the social network system regarding the good or service that is a subject of the digital marketing content. For example, the offer for “10% Off” provided to a user account may incentivize purchase of an associated good or service. The user at that user account that purchased the good or service may then post a review of the good or service via the social network service. This post, when output to other user accounts of the social network service, may then incentivize other users associated with these other user accounts to also purchase the good or service, even if these users are not provided with access to the offer.

To select the user accounts of the influential users, digital marketing systems typically employ influence maximization techniques to learn which subset of user accounts of a social network system are likely to have the greatest amount of influence on other users and associated user accounts of the system, e.g., to promote awareness or conversion of a good or service. The subset is selected to cause the greatest amount of influence on other user accounts of the social network, e.g., to cause aware or conversion of a good or service that is a subject of the digital marketing content. Influence maximization refers to techniques and systems used by a digital marketing system to maximize an effect of a viral marketing campaign or any other digital marketing campaign, e.g., an effect of an offer included in the digital marketing content on other user accounts of a social network system as described above.

However, conventional influence maximization techniques are inefficient and prone to error and thus often fail to accurately identify user accounts of a social network service that maximize an effect of digital marketing content. This is due to a requirement of conventional influence maximization techniques on knowledge of an underlying diffusion model of the social network system. The diffusion model describes how information propagates through the social network system, e.g., from user account to user account via posts, direct messages, and so forth. In real world scenarios, knowledge of an underlying diffusion model of the social network system and corresponding parameters is difficult if not nearly impossible to obtain by digital marketing systems, e.g., due to the number of users of the social network system, limited availability of this data, and so forth. Accordingly, conventional techniques used by digital marketing systems to perform influence maximization that rely on knowledge of the underlying diffusion model often fail for their intended purpose and are inefficient with regard to both computational performance and cost of providing the digital marketing content. Conventional techniques, for instance, may require an increased number of items of digital marketing content to be communicated, thereby increasing computational and network cost as well as a cost of the offers included as part of the content, itself.

### SUMMARY

Influence maximization determination within a social network system is described. In one example, a subset is selected by a digital marketing system from a plurality of user accounts of a social network system. The subset, for instance, may be selected from a plurality nodes, in which, each node of the plurality of nodes describes a respective user's interaction as part of the social network system. Exposure of digital marketing content is then caused to the subset of user accounts. A determination is made as to a probability of each user account of the plurality of user accounts as being influenced by the exposure of the digital marketing content to the subset. The determined probability is then output, such as to control output of digital marketing content, e.g., to implement influence maximization. In this way, the probability of influence that is determined between the user accounts may be used independent of a diffusion model as required by conventional influence maximization techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ influence maximization techniques described herein.

FIG. 2 depicts a system in an example implementation showing nodes of a social network system of FIG. 1 and a determination of influence probability data independent of knowledge of how information disseminates within the system.

FIG. 3 depicts a system in an example implementation showing operation of the influence determination module of FIG. 1 in greater detail.

FIG. 4 is a flow diagram depicting a procedure in an example implementation in which an influence maximization determination is used to control output of digital marketing content.

FIG. 5 depicts an example algorithm usable to perform influence maximization.

FIG. 6 illustrates an example system including various components of an example device that can be implemented as any type of computing device as described and/or utilize with reference to FIGS. 1-5 to implement embodiments of the techniques described herein.

### DETAILED DESCRIPTION

Overview

Influence maximization techniques and systems are described that may be performed independent of knowledge of how information diffuses within the social network system and with increased accuracy over conventional techniques. To do so, a digital marketing system learns a pairwise probability (e.g., directly from observed data from a social network service) that exposure of digital content to a first user account influences a second user account of the social network service. This pairwise probability thus describes “reachability” of the second user account as influenced by the first user account. It is this determination of the pairwise probability that supports the determination of influence (e.g., influence maximization) without knowledge of an underlying diffusion model as required in conventional influence maximization techniques. In other words, the techniques described herein are agnostic regarding a “how” the influence happened as a result of exposure to digital marketing content but rather “whether” the influence happened as observed through data collected from the social network system.

The social network system, for example, may be represented as a collection of user accounts (e.g., as “nodes”), which describe a respective user's interaction as part of the social network service. The digital marketing system then parameterizes the influence maximization problem in terms of probability that provision of digital marketing content to a user account of the subset of user accounts influences another user account, e.g., that has not been provided the item of digital marketing content. In other words, this probability describes a likelihood that a diffusion of digital marketing content starting from a user account in the social network system (e.g., a “seed”) will reach another user account in the social network system. This may also be considered as a “reachability” probability for each pair of user accounts, which is also referred to as a pairwise reachability probability in the following discussion. This parameterization enables the digital marketing system to perform influence maximization independent of knowledge of a diffusion map of the social network system, which is not possible using conventional techniques.

These probabilities may then be used by the digital marketing system to determine which user accounts of the subset of user accounts is likely to have the greatest amount of influence on other user accounts of the social network system. The digital marketing system may then repeat this process by selecting another subset of user accounts based at least in part of the probabilities computed from a previous iteration. This may be performed by the digital marketing system in a variety of ways, such as to address a tradeoff between exploration and exploitation. In exploration, user accounts are selected for inclusion in the subset by the digital marketing system to improve knowledge about how information is communicated within the social network system. In exploitation, user accounts are selected for inclusion in the subset by the digital marketing system to find user accounts to maximize “influence” as diffused through the social network system.

The digital marketing system may then control output of subsequent digital marketing content based on these probabilities, which may be refined over additional iterations. As a result, the digital marketing system may efficiently and accurately identify a subset of user accounts of the social network system that, when provided with digital marketing content, maximizes influence within the social network system. In this way, these techniques support both reduced costs in provision of digital marketing content as well as use of computational and network resources due to this efficiency. Further discussion of these and other examples is included in the following sections and shown in corresponding figures.

### Example Terms

“Digital Marketing Content” refers to digital content that is configured to increase awareness and/or cause an action (e.g., conversion) of an associated good or service. Digital marketing content may take a variety of forms, such as banner ads, electronic communications, posts, and so forth. A “digital marketing system” is configured to control output of and user exposure to digital marketing content.

A “social network system” is configured to support electronic communications between users associated with user devices to support social interactions and personal relationships. Examples of social network systems include Instagram®, Facebook®, Twitter®, LinkedIn®, and so forth.

“Influence maximization” refers to techniques and systems used to maximize an effect of a viral marketing campaign or any other digital marketing campaign. This maximization is realized by the digital marketing system through selection of a subset of user accounts (i.e., “seed”) that have the greatest likelihood of influencing (i.e., “reaching”) other users and associated user accounts of the social network system. Through use of influence maximization, for instance, the digital marketing system may maximize a budget of available digital marketing content, e.g., offers for discounts for goods or services.

“Nodes” of a social network system are logical entities, maintained in storage, that describe a respective user's interaction as part of the social network system. Nodes, for instance, may correspond to user accounts and thus describe a user's interaction regardless of a device used to perform that action. Other examples are also contemplated in which the user device, itself, is also referenced.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

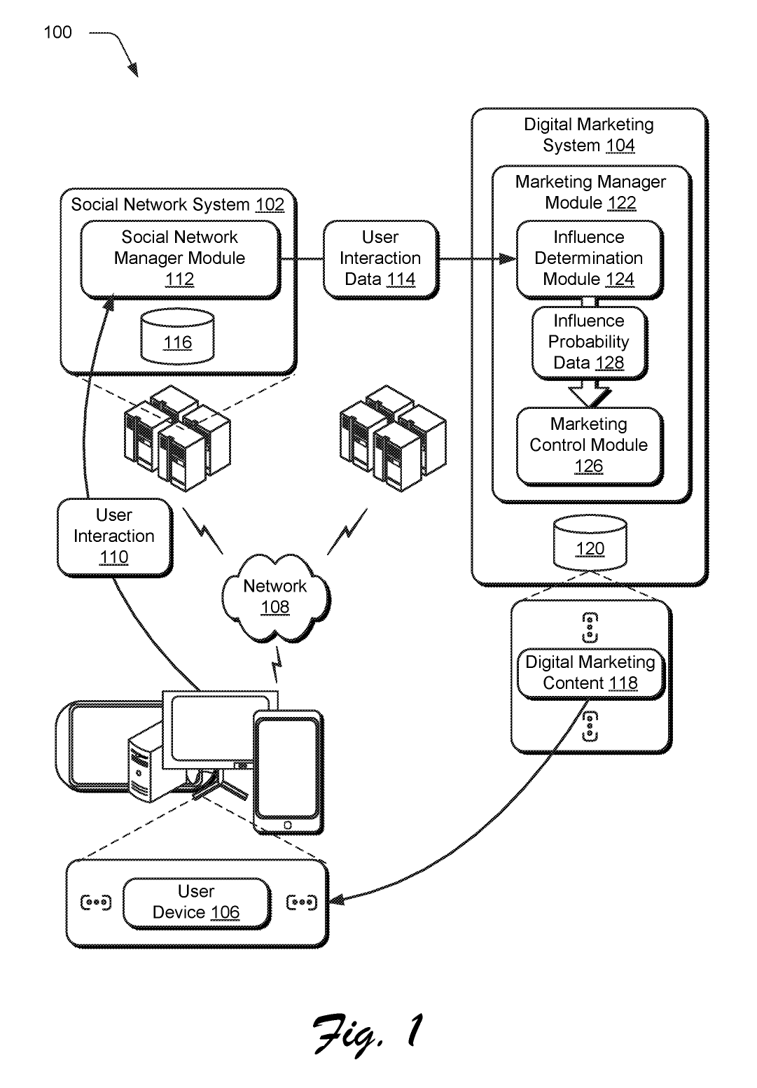

FIG. 1 is an illustration of a digital medium environment 100 in an example implementation that is operable to employ techniques described herein. The illustrated environment 100 includes a social network system 102, a digital marketing system 104, and a plurality of user devices, an example of which is illustrated as user device 106. These devices are communicatively coupled, one to another, via a network 108 and may be implemented by a computing device that may assume a wide variety of configurations.

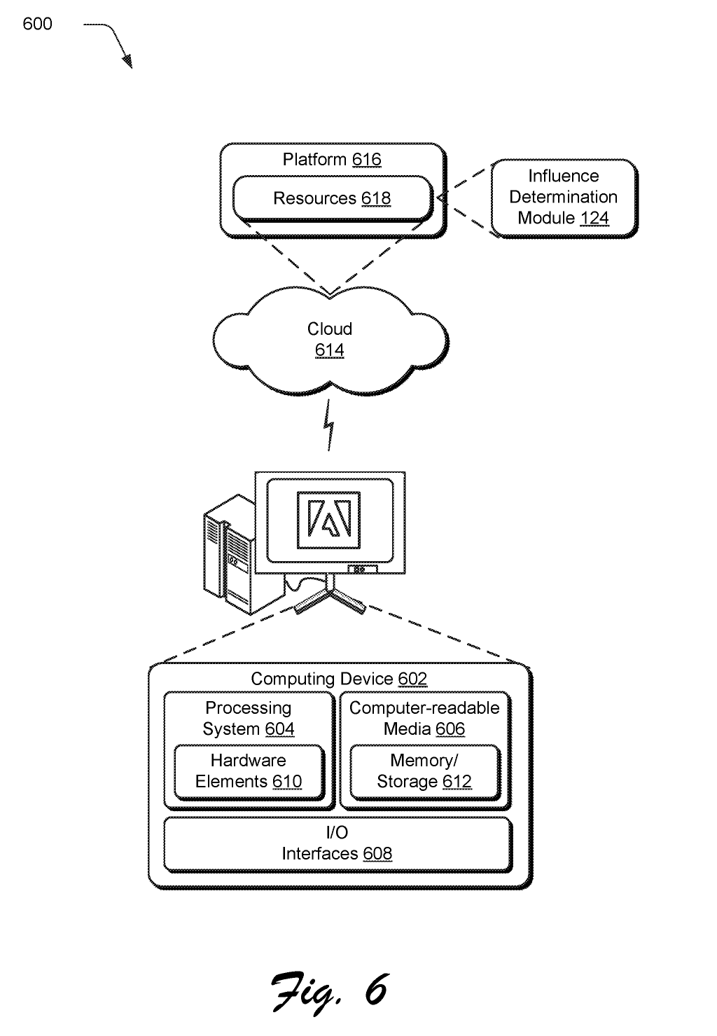

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, a computing device may be representative of a plurality of different devices, such as multiple servers utilized by a business to perform operations “over the cloud” as shown for the social network system 102 and the digital marketing system 104 and as further described in FIG. 6.

The user device 106 is illustrated as engaging in user interaction 110 with a social network manager module 122 of the social network system 102. The social network system 102, for instance, may be configured to support electronic communications between users and user accounts associated with the user devices 106 to support social interactions and personal relationships. Examples of user interactions 110 includes posts, messages, modification of user profiles, and so forth. Examples of social network systems include Instagram®, Facebook®, Twitter®, LinkedIn®, and so forth.

The social network manager module 112 is configured to generate user interaction data 114 that describes these user interactions. The user interaction data 114, for instance, may identify communications between user accounts, a subject of those communications, and so forth, which may be maintained in storage 116 of the social network system 102. As illustrated, the user interaction data 114 is provided by the social network system 102 to the digital marketing system 104 for use in controlling output of digital marketing content 118, which is illustrated as stored in storage 120 (e.g., a computer-readable storage medium) of the digital marketing system 104.

The digital marketing system 104 includes a marketing manager module 122 that is implemented by at least one computing device to control the output of the digital marketing content 118. Digital marketing content 118 may take a variety of forms, such as electronic messages, email, banner ads, posts, and so forth. The digital marketing content 118, for instance, may include an offer of a discount, a “buy one, get one free,” for a good or service. Accordingly, the digital marketing content 118 is typically employed to raise awareness and conversion of the good or service corresponding to the content.

Examples of functionality used to control output of the digital marketing content include an influence determination module 124 and a marketing control module 126. The influence determination module 124 is representative of functionality implemented by at least one computing device to generate influence probability data 128. The influence probability data 128 describes a likely amount of influence of users and user accounts associated with the user device 106 on each other as part of the social network system 102.

The influence probability data 128 is then used by a marketing control module 126 to control output of digital marketing content 118. The influence probability data 128, for instance, may be used to maximize an amount of influence exposure of the digital marketing content 118 has on user accounts of the social network system 102, which is referred to an influence maximization. The marketing control module 126, for instance, may select a subset of user accounts of the social network system 102 that are likely to influence the greatest number of other user accounts of the social network system 102, such as to increase an amount of awareness and/or conversion of a good or service. This is also referred to as “spread” in the following discussion.

As previously described, conventional techniques used to perform influence maximization require knowledge of how information diffuses between user accounts of the social network system 102, which is commonly referred to as a diffusion map. In the techniques described herein, however, the influence probability data 128 is generated by the influence determination module 124 independent of this knowledge, an example of which is described as follows and shown in a corresponding figure.

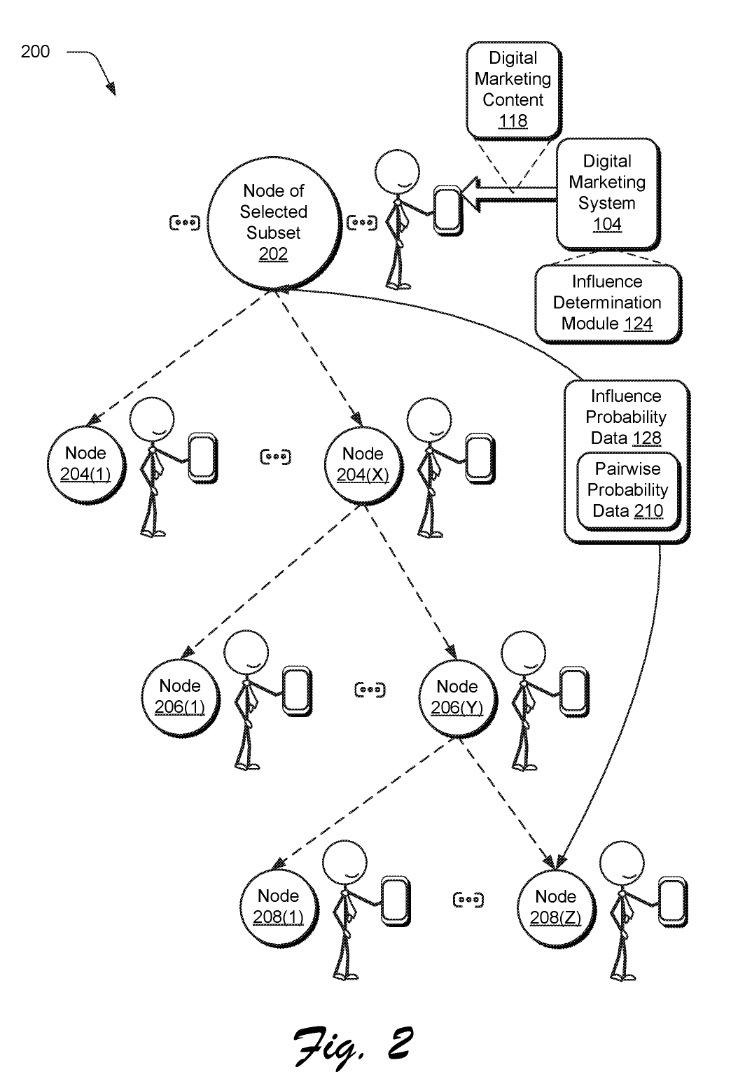

FIG. 2 depicts a graphical example 200 of diffusion between user accounts within a social network system 102 of FIG. 1. This graphical example is illustrated using a plurality of nodes, each of which represents a corresponding user and associated user account of the social network system 102. As illustrated, the digital marketing system 104 in this instance exposed digital marketing content 118 to a node of the selected subset 202 that acts as a “seed” in the social network system 102.

Exposure of the digital marketing content 118 then diffuses through different hierarchical levels of nodes 204(1)-204(X), 206(1)-206(Y), 208(1)-208(Z), and so on through the social network system. The node of the selected subset 202 of user accounts, for instance, that is exposed to the digital marketing content 118 (e.g., buy one/get one free for a good or service) may post on the social network system 102 “this product is great!” Nodes 204(1)-204(X) of user accounts at a next level of the hierarchy may then view this post, and further disseminate this information to nodes 206(1)-206(Y) in a next level of the hierarchy, e.g., by “sharing” the post. This process may continue and thus “spread” influence between nodes of the social network system 102.

As previously described, conventional influence maximization techniques require knowledge of how information is communicated between the nodes that represent the user accounts. This knowledge, however, is not readily available in real-world scenarios. Accordingly, in the techniques described herein the influence determination module 124 is configured to generate influence probability data 128 without knowledge of how information is communicated between the user accounts. In the illustrated example, for instance, pairwise probability data 210 may is generated by the influence determination module 124 that describes a probability that exposure of the digital marketing content 118 to the node of the selected subset 202 influences another node 208(Z). This is performed by computing pairwise probability data 210 (also referred to as pairwise reachability probabilities) as parametrizing the influence maximization problem.

This parametrization relies on the state of the network after the information diffusion has taken place, and not on “how” that diffusion takes place. Thus, since these techniques do not depend on knowledge of how information diffuses, it is agnostic to the underlying diffusion model (under a monotonicity assumption). Further discussion of selection of seeds and control of digital marketing content 118 output is described the following section and shown in corresponding figures.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Influence Maximization with a Social Network System

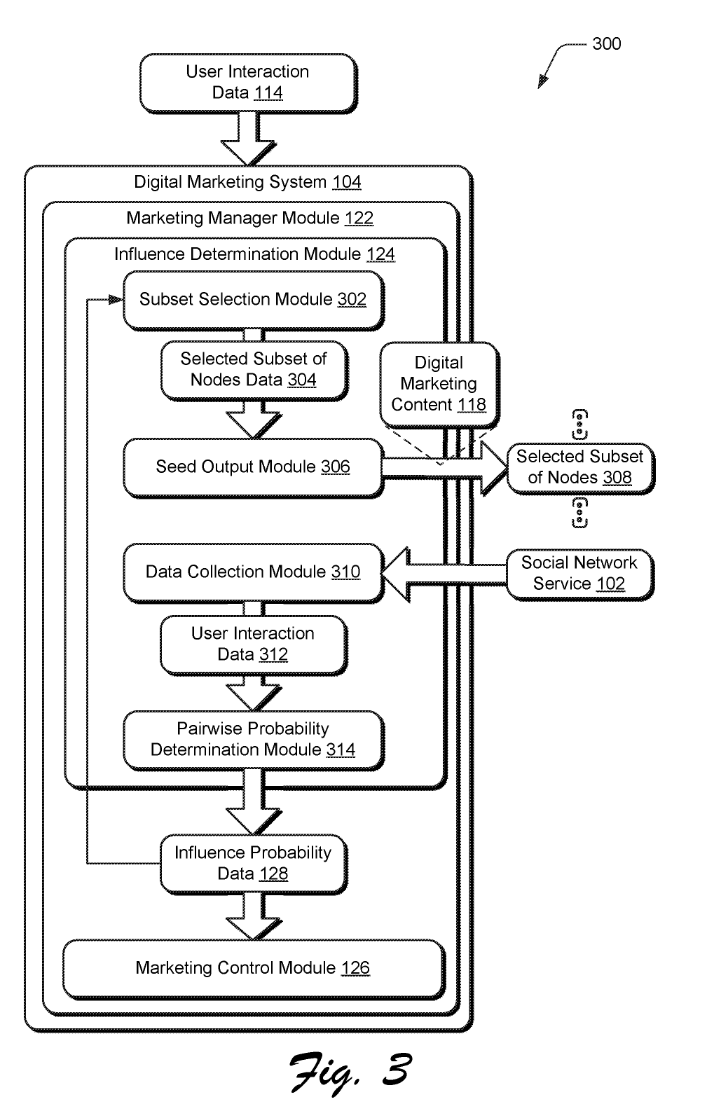

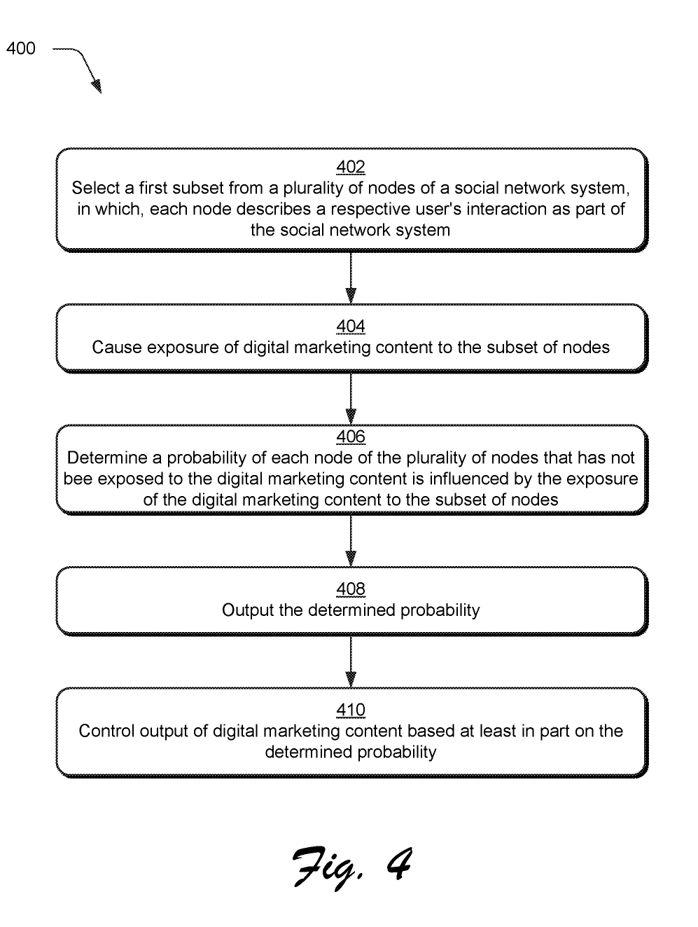

FIG. 3 depicts a system 300 in an example implementation showing operation of the influence determination module 124 of FIG. 1 in greater detail. FIG. 4 depicts a procedure 400 in an example implementation in which an influence maximization determination is used to control output of digital marketing content. In the following discussion, diffusion of communications between user accounts is described with respect to nodes.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 1-4.

To begin, the digital marketing system 104 collects user interaction data 114 that describes user interactions performed via the social network system 102. The user interaction data 114, for instance, may be arranged as nodes that correspond to respective users (e.g., user accounts) of the social network service 102 and thus may describe user interaction regardless of a user device 106 used to perform the interactions, e.g., mobile phone versus desktop computer to access the same user account.

A first subset is selected from a plurality of nodes (i.e., user accounts) of a social network system, in which, each node of the plurality of nodes describes a respective user's interaction as part of the social network system (block 402). A subset selection module 302, for instance, is implemented at least partially in hardware to generate a selected subset of nodes data 304 that describes a subset of user accounts represented as nodes from possible subsets of nodes of the social network system 102 to act as a “seed” for receipt of digital marketing content 118. In this example, this begins with a “preliminary” selection of the subset, which may be based on heuristics, previous applications of the techniques described herein to select the subset, and so on by the subset selection module 302.

Exposure of digital marketing content is then caused to the first subset of nodes (block 404). The selected subset of nodes data 304, for instance, is then provided to a seed output module 306. The seed output module 306 is implemented at least partially in hardware of a computing device to cause output of the digital marketing content 118 to the selected first subset of nodes 308 of the social network system 102.

A determination is made as to a probability of each node of the plurality of nodes that has not been exposed to the digital marketing content as being influenced by the exposure of the digital marketing content to the subset of nodes (block 406). A data collection module 310 of the influence determination module 124, for instance, may collect user interaction data 312 that describes a state of nodes of the social network system 102 after exposure of the digital marketing content 118 to the first subset. The user interaction data 312 is then used by a pairwise probability module 314 to generate influence probability data 128 that describes the probability of each node of the plurality of nodes, which has not been exposed, as being influenced by the exposure of the digital marketing content to the selected subset of nodes 308.

The determined probability is then output (block 408), such as to control output of digital marketing content (block 410). The influence probability data 128, for instance, may be output to the marketing control module 126 to control subsequent output of the digital marketing content 118. This may be performed as part of influence maximization by provide the digital marketing content 118, based on the influence probability data 128, to maximize influence of this content on other users of the social network system 102.

In another example, the influence probability data 128 is provided back to the subset selection module 302 to repeat this process to select a second subset and thus refine and further expand on a determination of influence within the social network system 102. This is illustrated through use of an arrow from the influence probability data 128 back to the subset selection module 302.

The influence determination module 124, for instance, is tasked with selecting a subset of nodes that are likely to have the greatest influence on other nodes in the social network system 102, while simultaneously learning the factors affecting information propagation. Accordingly, in this example the influence determination module 124 employs an influence maximization “semi-bandit” technique. The influence determination module 124, for instance, performs the above described influence maximization technique over multiple “rounds” to select first, second, third, fourth subsets and learns about the factors governing the diffusion from these rounds. Each round corresponds to an influence maximization attempt for the same or similar goods or services that are a subject of the digital marketing content. Further discussion of these and other examples is included in the following section.

Implementation Example

Influence maximization (IM) is characterized in the following discussion by a triple “( [symbol] , [symbol] , [symbol] ),” where “ [symbol] ” is a directed graph encoding a topology of the social network system 102, “ [symbol] ” is the collection of feasible seed sets, and “ [symbol] ” is the underlying diffusion model. Specifically, “ [symbol] =( [symbol] ,ε)” where “ [symbol] ={1, 2, . . . , [symbol] }” and “ε” are node and edge sets of the directed graph “ [symbol] ,” with cardinalities “ [symbol] =| [symbol] |” and “ [symbol] =|ε|,” respectively. The collection of feasible seed sets “ [symbol] ” is determined by influence determination module 124 of the digital marketing system 104 based on a cardinality constraint of “| [symbol] |≤K, ∀ [symbol] ∈ [symbol] ,” for some “K≤ [symbol] ,” and may also include combinatorial constraints (e.g. matroid constraints) that are used to rule out some subsets of “ [symbol] ” implying “ [symbol] ⊆{ [symbol] ⊆ [symbol] :| [symbol] |≤K}.”

A diffusion model “ [symbol] ” specifies a stochastic process under which influence is propagated across the social network system 102 once a seed set “ [symbol] ∈ [symbol] ” is selected, i.e., a seed set is select from the collection of feasible seed sets. Without loss of generality, an assumption may be employed by the digital marketing system 104 that all stochasticity in the directed graph “ [symbol] ” is encoded in a random vector “w,” referred to as a diffusion random vector. An assumption is also employed that each diffusion has a corresponding vector “w” sampled independently from an underlying probability distribution “ [symbol] ” specific to the diffusion model. For diffusion models such as independent cascade (IC) and linear threshold (LT), “w” corresponds to an “m”-dimensional binary vector encoding edge activations for each of the edges in “ε,” and “ [symbol] ” is parameterized by “m” influence probabilities, one for each edge. Once “w” is sampled, an expression “ [symbol] (w)” is used in the following discussion to refer to the particular realization of the diffusion model “ [symbol] .” By definition, “ [symbol] (w)” is deterministic, conditioned on “w.”

Given the above definitions, diffusion between nodes in the social network system 102 is described as follows. First, the digital marketing system 104 chooses a seed set “ [symbol] ∈ [symbol] ” and then independently samples data from the social network system 102 as a diffusion random vector “w˜ [symbol] ,” i.e., the user interaction data 114. The influenced nodes in the diffusion are completely determined by “ [symbol] ” and “ [symbol] (w).” The indicator “I( [symbol] , [symbol] , [symbol] ,(w))∈{0.1}” is used to denote if the node “v” is influenced under the seed set “ [symbol] ” and the particular realization “ [symbol] (w).” For a given “( [symbol] , [symbol] ),” once a seed set “ [symbol] ⊆ [symbol] ” is selected, for each node “ [symbol] ⊆ [symbol] ,” the value “F(S, [symbol] )” denotes the probability that “ [symbol] ” is influenced under the seed set as follows:

F(S, [symbol] )= [symbol] [I(S, [symbol] , [symbol] (w))|S]

where the expectation is defined over each possible realization “ [symbol] (w).” The expected number of nodes that are influenced as a result of selection of the seed set “S” is denoted by “F(S)=Σ_{V∈V}F(S, [symbol] ).”

Influence maximization is used by the digital marketing system 104 to maximize “F(S)” subject to a constraint “ [symbol] ∈ [symbol] ”, i.e., to find “S*∈arg max [symbol] .” Although influence maximization is an NP-hard (nondeterministic polynomial) problem in general, under diffusion models such as independent cascade (IC) and linear threshold (LT), the objective function “F(S)” is monotone and submodular. Thus, a near-optimal solution may be efficiently computed by the influence determination module 124 of the digital marketing system 104 using a greedy algorithm In the following discussion, an assumption is employed by the digital marketing system 104 that “ [symbol] ” is any diffusion model satisfying the following monotonicity assumption:
Assumption 1. For any “ [symbol] ∈V, F(S, [symbol] )” is monotone in “S” i.e., “F(S₁, [symbol] )≤F(S₂, [symbol] ), if S₁⊆S₂.” Note that all progressive diffusion models (models where once the user is influenced, this state cannot be changed) satisfy Assumption 1.

Surrogate Objective

A surrogate objective is now described for influence maximization based on the notion of maximal pairwise reachability. For any set “S⊆ [symbol] ” and any set of pairwise probabilities “p: [symbol] × [symbol] →[0,1],” for all nodes “ [symbol] ∈ [symbol] ,” the following is defined:

f(s, [symbol] ,p)=max_{u∈S}

[symbol]

where “ [symbol] ” is the pairwise probability associated with the ordered node pair “(u, [symbol] )”, i.e., the probability that influence of one node reaches another node. The following is also defined “F(S,p)= [symbol] f(S, [symbol] ,p)” in which “f(S,p)” is monotone and submodular in “S.” For any pair of nodes “u, [symbol] ∈ [symbol] ,” pairwise “reachability” from “u” to “ [symbol] ” is expressed as “pᵤ*=F({u}, [symbol] ),” i.e., the probability that “ [symbol] ” is influenced, if “u” is the only seed node under graph “ [symbol] ” and diffusion model “ [symbol] .” Moreover, “f(S, [symbol] ,p*)=max_{u∈s}pu, [symbol] ” describes the maximal pairwise reachability probability from the seed set “S” to the target node “ [symbol] .” An example of a surrogate objective for influence maximization is “f(S,p*)= [symbol] f(s, [symbol] ,p*).” Based on this objective, an approximate solution “\tilde{S}” to influence maximization may be obtained by maximizing f(S,p*) under the constraint [symbol] ∈ [symbol] ,

\tilde{S}∈arg max [symbol] f(S,p*)

From above, “S*” is the optimal solution to an influence maximization problem that is solved by the influence determination module (e.g., the influence probability data) of the digital marketing system 104 in the following discussion. To quantify the quality of the surrogate, the surrogate approximation factor is defined as “ρ=f(\tilde{S},p*)/F(S*).” The upper and lower bounds may be obtained on “ρ” as follows:
Theorem 1. For any graph “ [symbol] ,” seed set “ [symbol] ∈ [symbol] ,” and diffusion model “ [symbol] ” satisfying Assumption 1,

1 f(S,p*)≤F(S),

2 If F(S) is submodular in S, then 1/K≤ρ≤1.

This Theorem implies that for any progressive model satisfying assumption 1, maximizing “f(S,p*)” is the same as maximizing a lower-bound on a true spread “F(S)” and thus “f(S,p*)” may serve as a good approximation to “F(S).” For both independent cascade (IC) and linear threshold (LT) models, “F(S)” is both monotone and submodular, and the approximation factor can be lower-bounded by 1/K. In the following discussion, it is shown empirically that “ρ” is significantly larger than “1/K.”

Finally, note that solving “\tilde{S}∈arg max [symbol] f(S,p*)” is typically computationally intractable, e.g., in real world scenarios. Thus, a near-optimal solution of max [symbol] f(S,p*) is computed by the influence determination module 124 of the digital marketing system 104 in the following based on an approximation algorithm, which are referred to as oracles to distinguish this algorithm from learning algorithms for ease of the discussion. Therefore, in the following discussion let “ORACLE” be such an oracle and let “\tilde{S} [symbol] ORACLE ( [symbol] , [symbol] ,p)” be the seed set output by this oracle. For any “α∈[0,1],” “ORACLE” is an α-approximation algorithm if for all “ [symbol] × [symbol] →[0,1], f(Ŝ,p)≥α max [symbol] f(S,p).”

Influence Maximization Semi-Bandits

In an influence maximization semi-bandit problem (also characterized by the triple ( [symbol] , [symbol] , [symbol] )), the digital marketing system 104 is aware of both “ [symbol] ” and “ [symbol] ,” but is not aware of the diffusion model “ [symbol] .” Specifically, the digital marketing system 104 is not aware of the model class of “ [symbol] ” (e.g., if [symbol] is independent cascade (IC) and linear threshold (LT)) nor its parameters, e.g. influence probabilities for independent cascade (IC) and linear threshold (LT). Consider a scenario in which the digital marketing system 104 interacts with the social network system 102 for “T” rounds. At each round “t∈{1, . . . , T},” the digital marketing system 104 first chooses a seed set “Sₜ∈ [symbol] ,” e.g., based on prior knowledge and past observations. The digital marketing system 104 then independently samples a diffusion random “wₜ˜ [symbol] ” as part of collection of user interaction data 114. Influence thus diffuses in the social network system 102 from “Sₜ” according to “ [symbol] (wₜ).” The “reward” at round “t” is the number of the influenced nodes as follows:

rₜ= [symbol] I(Sₜ, [symbol] , [symbol] (wₜ)).

Recall that by definition, “ [symbol] [rₜ|Sₜ, [symbol] (wₜ); [symbol] ]=F(Sₜ).” After each such influence maximization attempt, the digital marketing system 104 observes the pairwise influence feedback (described next) and uses this feedback to improve the subsequent influence maximization attempts, e.g., to select seeds having a greater influence. To do so, the digital marketing system's 104 objective is to maximize the expected cumulative reward across the “T” rounds (i.e., to maximize [symbol] [ΣTₜ₌₁^{T}rₜ]), which is equivalent to minimizing the “cumulative regret” defined subsequently.

An influence maximization semi-bandit feedback model is described as follows which is referred to as pairwise influence feedback. Under this feedback model, at the end of each round “t,” the digital marketing system 104 observes “I({u}, [symbol] , [symbol] (wₜ))” for all “u∈Sₑ” and all “ [symbol] ∈ [symbol] .” In other words, digital marketing system 104 observes whether or not “v” would be influenced, if the digital marketing system 104 selects “S={u}” as the seed set under the diffusion model [symbol] (wₜ).

This form of semi-bandit feedback may be employed by the digital marketing system 104 in a variety of influence maximization scenarios. For example, on a social network system 102 such as Facebook®, a user who influenced another user to “share” or “like” an article may be readily identified. Thus, the propagation to the seed which started the diffusion may be readily traced, transitively, through the social network system 102. Similarly, for product adoption, the a social network system 102 may track of the navigation behavior as part of user interaction with the system and thus can identify which other user caused the person to adopt a particular product or service.

Parametrizing the influence maximization problem in terms of reachability probabilities results in [symbol] (n²) parameters that are to be earned. Without any structural assumptions, this becomes intractable for large social network systems, e.g., which may have over a billion users. Accordingly, a linear generalization assumption is employed by the digital marketing system 104 in one example to develop statistically efficient algorithms for large-scale influence maximization semi-bandits. Assume, for instance, that each node “ [symbol] ∈ [symbol] ” is associated with two vectors of dimension d, the seed (source) feature and the target feature θᵥ*∈ [symbol] ^{d} and that the target feature “xᵥ*∈ [symbol] ^{d}” is known, whereas “θᵥ*” is unknown and needs to be learned. The linear generalization assumption is stated as follows:
Assumption 2. For all u, [symbol] ∈ [symbol] , p_{u,v}* can be “well approximated” by the inner product of “θᵤ*” and “ [symbol] ” in other words:

[symbol]

≈ [symbol] θᵤ*,xᵥ [symbol] [symbol] xᵥ^{T}θᵤ*

Note that for the tabular case (the case without generalization across “ [symbol] ′s”), “xᵥ= [symbol] ∈ [symbol] ⁿ” and “θᵤ*=[p_{u,1}*, . . . , p_{u,n}*]” may be chosen, where “ [symbol] ” is an indicator vector with the “ [symbol] -th” element equal to one and each of the other elements equal to zero. However, in this case “d=n,” which is not desirable and construction of target features when “d<<n,” is nontrivial. An example of a feature construction approach based on the unweighted graph Laplacian is included in the following description in which a matrix “X∈ [symbol] ^{d×n}” is used to encode the target features. Specifically, for “ [symbol] =1, . . . , n,” the “ [symbol] -th” column of “X” is set as “ [symbol] .” Note that “X=I∈ [symbol] ^{n×n}” in the tabular case.

Finally, note that under Assumption 2, estimating the reachability probabilities becomes equivalent to estimating “n” (one for each source) “d-dimensional” seed feature vectors. This implies that Assumption 2 reduces the number of parameters to learn from “ [symbol] (n²)” to “ [symbol] (dn)” and thus, supports a statistically efficient algorithm for large-scale influence maximization semi-bandits. Performance of the influence maximization semi-bandit algorithm may be benchmarked by comparing its spread against the attainable influence assuming perfect knowledge of “D.” Since various approximations might be used for computing the seed set, the performance of an IM semi-bandit algorithm may be measured by scaled cumulative regret. Specifically, if “Sₜ” is the seed set selected by the influence maximization semi-bandit algorithm by the digital marketing system 104 at round “t,” for any “ [symbol] ∈(0,1)” the K-scaled cumulative regret “R^{k}(T)” in the first “T” rounds is defined as follows:

$${R}^{k} ( T ) = T \cdot F ( {S}^{*} ) - \frac{1}{K} 𝔼 [ {\sum }_{t = 1}^{T} F ( {S}_{t} ) ] .$$

Example Algorithm

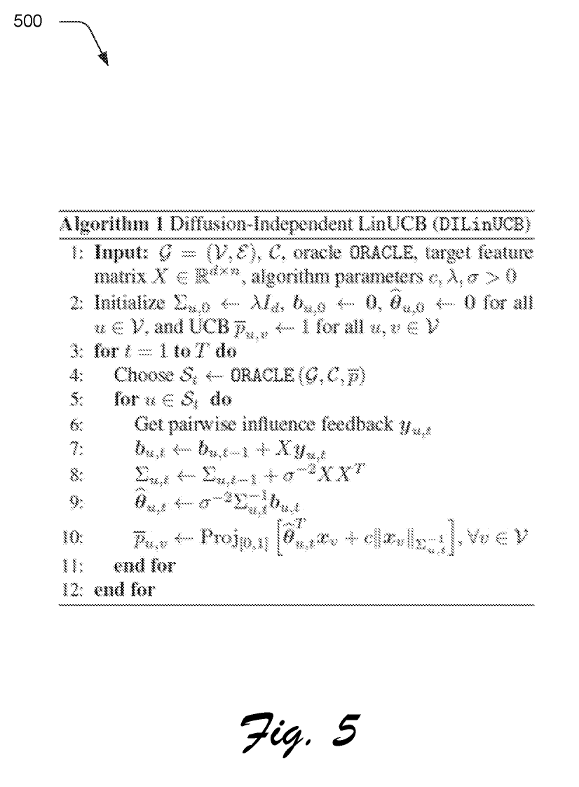

In this section, an LinUCB-based influence maximization semi-bandit algorithm is described, referred to as Diffusion-Independent Lin-UCB (DILinUCB), having an example of pseudocode 500 in Algorithm 1 of FIG. 5. As described as part of the name, DILinUCB is independent of the underlying diffusion model D of the influence maximization semi-bandit, and thus, is applicable to influence maximization semi-bandits with knowledge of the diffusion model “D.”

The inputs to DILinUCB include the network topology “ [symbol] ,” the collection of the feasible sets “C,” a combinatorial optimization algorithm “ORACLE,” the target feature matrix “X,” and three algorithm parameters “c,λ,σ>0.” The value “λ” specifies initial values of Gram matrices and may act as a regularization parameter. The value “σ” controls the learning rate and the value “c” controls the “degree of optimism” in the UCB estimates and hence trades off exploration (e.g., finding new nodes) and exploitation (e.g., use of found nodes). For each source node “u∈ [symbol] ” and time “t,” the Gram matrix is defined as “Σ_{u,t}∈ [symbol] ^{d×d},” and “b_{u,t}∈ [symbol] ^{d}” as the vector summarizing the past pairwise influences from “u.” Note that “Σ_{u,t}” and “b_{u,t}” are statistics for computing UCB estimates for “ [symbol] ” for all “u∈ [symbol] .”

At each round “t,” DILinUCB as implemented by the influence determination module 124 of the digital marketing system 104 first uses the existing UCB estimates to compute the seed set Sₜ based on the given oracle ORACLE, e.g., line 4 of Algorithm 1 of FIG. 5. Then, the pairwise reachability vector “y_{u,t}” is observed for each of the selected seeds in “Sₜ.” Specifically, the vector “y_{u,t}” includes “n” binary observations, such that “y_{u,t}=I({u}, [symbol] , [symbol] (wₜ))” indicates whether node “ [symbol] ” is reachable from the source “u” at round “t.” Finally, for each of the “K” selected seeds “u∈Sₜ,” DILinUCB as implemented by the influence determination module 124 of the digital marketing system 104 updates the statistics (lines 7 and 8) and updates the UCB estimates (line 10 of Algorithm 1 of FIG. 5). Note that “Proj_{[0,1]}[⋅]” projects a real number onto the interval [0,1], and ∥xᵥ∥_{Σ}_{_{u,t}}_{^{−1}}=\sqrt{ [symbol]Σ_{u,t}⁻¹ [symbol] ᵥ}.

Real-World Implementation Example

DILinUCB is applicable with any target feature matrix “X,” although in practice, its performance is highly dependent on the “quality” of “X.” Accordingly, a systematic feature construction approach is described in this section which is based on the unweighted Laplacian matrix of the network topology “ [symbol] .” For each “u∈ [symbol] ,” for instance, let “pᵤ∈ [symbol] ⁿ” be the vector encoding the reachability from the seed “u” to each of the target nodes “u∈ [symbol] .” Intuitively, “pᵤ*u” tends to be a smooth graph function in the sense that target nodes close to each other (e.g., in the same community) tend to have similar reachability from “u.” A smooth graph function (in this case, the reachability from a source) can be expressed as a linear combination of eigenvectors of the weighted Laplacian of the network. In this case, the edge weights correspond to influence probabilities and are unknown in the influence maximization semi-bandit setting. However, the above intuition may be used to construct target features based on the unweighted Laplacian of “ [symbol] .” Specifically, for a given “d=1, 2, . . . , n,” the feature matrix “X” is set to the bottom “d” eigenvectors (associated with “d” smallest eigenvalues) of the unweighted Laplacian of “ [symbol] .” Other approaches to construct target features include the neighborhood preserving node-level features.

One limitation of the example DILinUCB algorithm is that it does not generalize across the seed nodes “u.” Specifically, this example learns the source node feature “θᵤ*” for each source node “u” separately, which is inefficient for large-scale semi-bandit influence maximization problems. Note that similar to target features, the source features also tend to be smooth in the sense that “∥θᵤ₁*−θᵤ₂*∥₂” is “small” if nodes “u₁” and “u₂” are connected. This intuition is leveraged to design a prior which ties together the source features for different nodes, and hence transfers information between these nodes. Specifically, at each round “t,” the values “\hat{θ}ᵤ” are computed by minimizing the following objective “θᵤ′”:

$${\sum }_{j = 1}^{t} {\sum }_{u ∈ {S}_{t}} {( {y}_{u , j} - {X}^{T} {θ}_{u} )}^{2} + {λ}_{2} {\sum }_{( {u}_{1} , {u}_{2} ) ∈ ɛ} {‖ {θ}_{{u}_{1}} - {θ}_{{u}_{2}} ‖}_{2}^{2}$$

where “λ₂≥0” is a regularization parameter.

In regards to the computational complexity of DILinUCB, note that at each time “t,” DILinUCB first computes a solution “Sₜ” based on “ORACLE,” and then updates the UCBs. Since “Σ_{u,t}” is positive semi-definite, the linear system in line 9 of algorithm 1 of FIG. 5 may be solved using conjugate gradient in “O(d²)” time. Thus, the computational complexity to update the UCBs is “O(Knd²).” The computational complexity to compute “Sₜ” is dependent on “ORACLE.” For the classical setting in which “C={S⊆ [symbol] :|S|≤K}” and “ORACLE” is a greedy algorithm, the computational complexity is “O(Kn).” Lazy evaluations for submodular maximization may be employed to increase efficiency, which results in sub-Kn time complexity for seed set selection.

Example System and Device

FIG. 6 illustrates an example system generally at 600 that includes an example computing device 602 that is representative of one or more computing systems and/or devices that may implement the various techniques described herein. This is illustrated through inclusion of the influence determination module 124. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to determine user influence within a social network system, a method implemented by at least one computing device, the method comprising:
selecting, by the at least one computing device, a first subset from a plurality of user accounts of a social network system;
collecting, by the at least one computing device, user interaction data describing interactions of the plurality of user accounts via the social network system subsequent to exposure of digital marketing content to the first subset of user accounts;
determining, by the at least one computing device from the user interaction data, a pairwise probability that a user account of the subset of the user accounts influences a user account of the plurality of user accounts that is not exposed to the digital marketing content;
selecting, by the at least one computing device, another subset from the plurality of user accounts based at least in part on the determined pairwise probability; and
controlling, by the at least one computing device, output of subsequent digital marketing content to the second subset.

2. The method as described in claim 1, wherein the second subset includes at least one user account of the plurality of user accounts that is not included in the first subset.

3. The method as described in claim 1, wherein the influencing involves causation of performance of an action by a respective said user account.

4. The method as described in claim 1, further comprising repeating the determining and the selecting based on the second subset.

5. The method as described in claim 1, further comprising controlling, by the at least one computing device, output of the digital marketing content to the first subset.

6. The method as described in claim 1, wherein the determining is performed independent of knowledge of a diffusion model that describes how information propagates between the plurality of user accounts of the social network system.

7. The method as described in claim 1, wherein the determining of the probability is performed by optimizing an approximation of a lower bound of an objective function regarding a spread of influence between user accounts of the social network system.

8. The method as described in claim 7, wherein the determining is also performed using a upper confidence bounds based linear bandit algorithm.

9. The method as described in claim 1, wherein the probability describes whether or not each user account of the plurality of user accounts is influenced by a respective user account of the subset of user accounts.

10. In a digital medium environment to determine user influence within a social network system, a system comprising:
a subset selection module implemented at least partially in hardware of at least one computing device to select a subset from a plurality of user accounts of a social network system, in which each said user account describes a respective user's interaction as part of the social network system;
a seed output module implemented at least partially in hardware of the at least one computing device to cause exposure of digital marketing content to the subset of user accounts;
a data collection module implemented at least partially in hardware of the at least one computing device to collect user interaction data describing a result of the exposure on the plurality of user accounts of the social network system; and
a pairwise probability determination module implemented at least partially in hardware of the at least one computing device to generate influence probability data from the user interaction data, the influence probability data describing a pairwise probability that user accounts of the subset of the user accounts influence user accounts of the plurality of user accounts that are not exposed to the digital marketing content.

11. The system as described in claim 10, wherein the probability is a pairwise probability that describes reachability of user accounts of the plurality of user accounts that are not exposed to the digital marketing content by user accounts of the subset.

12. The system as described in claim 10, wherein the influencing involves causation of performance of an action by a respective said user account.

13. The system as described in claim 10, wherein the subset selection module is further configured to select another subset from the plurality of user accounts based on the determined probability.

14. The system as described in claim 10, further comprising a marketing control module implemented at least partially in hardware of the at least one computing device to control output of digital marketing content based at least in part on the influence probability data.

15. The system as described in claim 10, the pairwise probability determination module is configured to generate the influence probability data without reliance on knowledge of a diffusion model that describes how information propagates between the plurality of user accounts of the social network system.

16. In a digital medium environment to determine user influence within a social network system, a system comprising:
means for selecting a first subset from a plurality of user accounts of a social network system;
means for causing exposure of digital marketing content to the first subset of user accounts;
means for determining pairwise probability that user accounts of the first subset of the user accounts influence user accounts of the plurality of user accounts that are not exposed to the digital marketing content; and
means for selecting a second subset from the plurality of user accounts based on the determined pairwise probability.

17. The system as described in claim 16, wherein the second subset includes at least one user account of the plurality of user accounts that is not included in the first subset.

18. The system as described in claim 16, wherein the causing means is further configured to cause exposure of subsequent digital marketing content to the second subset.

19. The system as described in claim 16, further comprising means for controlling output of digital marketing content based at least in part on the determined probability.

20. The system as described in claim 16, wherein the determining means is configured to perform independent of knowledge of a diffusion model that describes how information propagates between the plurality of user accounts of the social network system.
